(19) United States
(12) Patent Application Publication
(10) Pub. No.: US 2005/0135667 A1
(43) Pub. Date: Jun. 23, 2005

(54) Method and apparatus for labeling images and creating training material

(75) Inventors: Antti Saarela, Vantaa (FI); Juhani Rauhamaa, Espoo (FI)

Correspondence Address: Michael M. Rickin, Esq.;ABB Inc., Legal Department - 4U6, 29801 Euclid Avenue, Wickliffe, OH, 44092-2530, US

(73) Assignee: ABB Oy.

(21) Appl. No.: 10/745,314

(22) Filed: Dec. 22, 2003

(51) Int. Cl. G06K 9/00

(52) U.S. Cl. 382/141

(57) ABSTRACT

A method for labeling images that have a visual appearance digitizes the images in order to create image data. The method calculates plurality of features from a subset of said image data and organizes the images unsupervised in an organization process. The organizing is based on the features and the similarity criterion. After the set of images is retrieved utilizing the organization of the stored images, a label is assigned to the retrieved image or to its part. As well the labels are verified and training material is created for a supervised classifier.

### BACKGROUND OF THE INVENTION

1. Field of the Invention

The present invention relates to a method for labeling of images having a visual appearance. Further the invention relates to a method for creating training material needed for a supervised classifier. Especially the invention is applicable in the area of detecting defects on the sheetlike material, as paper, metal, glass fiber, non-woven, plastic etc.

2. Description of the Prior Art

Any supervised classifier uses a reference set of manually classified samples. For a supervised image based classifier manual classification of example images is needed. These named, or labeled, sample images are here referred to as the training material. The quality of the results of a supervised classifier depends mainly on two things: the quality of the measured features and the quality of the training material. The more complete the training material, the better the classification results are for new samples. By ‘complete’ it is meant that all different variants of defects are presented in the training material for all classes.

The number of example images needed for good classification results depends on the number of different classes used. The similarity of classified images also affects the desired size of the training material. As an example, a typical paper web defect classifier capable for classifying defects into twenty or more classes can utilize over four thousand example images with results improving as the amount of training material increases. The examples selected to be part of the training material are picked up from a vast amount of images. In a typical paper web classification problem, the number of available defect images can exceed fifty thousand images, from which the majority consists of repeating and almost identical defects. The search for usable images to be added to the training material is both a time-consuming and a frustrating task when done in a conventional image-by-image manner.

In this context the act of assigning a label to an image consists of showing a user an image and the user giving a label to that particular image. The labeling of an image refers to both labeling an entire image and to labeling some object or objects represented by the image. The labeling of an image can also consist of more than one label in one or multiple label categories. The verifying of a label is in this context defined as an act of inspecting or viewing an existing labeling. This is enabled by showing the image and the corresponding label at the same time or by showing the images with a selected label only. The visual appearance of an image is henceforth defined as a property of the image or a set of objects in the image, which by some means describes the visual information contained in that image. The visual appearance encloses all such measured or defined features of the image or a set of objects in the image that reflect changes in the form, color or intensity of those entities. Self-organizing map algorithm (SOM), as described in “Self-organizing Maps” by Kohonen T, Springer Verlag, Berlin 1995, pp. 77-130 (Kohonen), is an algorithm for visualizing multi-dimensional data on an organized low-dimensional map. The organization of the data is topology preserving. Although the dimensionality of the data may be reduced heavily, the intention is to preserve the spatial relationships of the data points. The multi-dimensional inner-data distances are mapped to low-dimensional distances on the map, leading to an organized presentation of the data, where similar data points tend to be near to each other on the map also. The map converts complex, nonlinear statistical relationships between high-dimensional data vectors into simplified geometric relationships on a low-dimensional display. The algorithm compresses information while preserving the most important topological and metric relationships of the data vectors. The SOM usually consists of a two-dimensional regular grid of nodes. A model vector is associated with each map node. The model vectors are organized into a meaningful two-dimensional order in which similar model vectors are closer to each other in the grid than the more dissimilar ones. The computation of the SOM is a nonparametric, recursive regression process which will described later in detail.

Conventionally, the images of a large image collection have been labeled one by one in random order or after sorting the images by some criteria, for example the size of the image. When labeling images in such a manner, no overall idea of the images to be labeled can be created until at least one pass is made through the whole image data. On the basis of visual observations, it is often difficult to perceive which are the existing groups in the whole image data. Therefore, in conventional solutions several passes are typically needed. This is especially true for images of defects because defect classes are often fuzzy or imprecisely defined. It is not uncommon that the image data set may even contain previously unseen defect types. The labeling is then based only on the user's ability to remember the variations and properties of each image group to be labeled with a unique label. Therefore, immediate labeling of an image can be impossible and additional passes are required for making or correcting the labeling.

It has been suggested in Vuorilehto J, “Machine Vision News”, volume 8, Vision Club of Finland, Forssan Kirjapaino 2003, page 10 (Vuorilehto), that images could be organized by a self-organizing map based on their visual appearance. In Vuorilehto, the self-organizing map has not been used for the labeling individual images but instead as a classifier aimed for classifying images based on the labeling of the nodes of the self-organizing map. Actually as described, this suggestion does not allow for the labeling of any of the individual images.

The organization and visualization of the images can also be achieved by utilizing other algorithms, for example K-means clustering followed by sorting the cluster representatives by some means. Also linear or non-linear principal component analysis can be utilized for organizing the data automatically without any need for selection of any sorting criteria. These algorithms as such nevertheless lack the ability of dividing the data into any meaningful groups and the organization is based on the two principal axes. Without the automatic grouping of images the selection of the representative images must be considered carefully before implementing a system based on any variant of these algorithms. The organization of the images need not be error-free or computer resource friendly, as it is used as a visualization tool in a non-time-critical task. Both of the aforementioned demands are typical for a supervised image classifier.

When labeling images of an image collection, the images must be visualized and the whole image material traversed through by some means. Browsing through images linearly or in random order creates a high risk for creating inconsistent or even contradictory labeling. Also the risk for defining several different labels for images that could share one label only will be considerable.

For many types of supervised image classifiers a huge amount of training samples may be needed for acceptable automatic classification results. Memorizing and managing thousands of image-to-class label-mappings is demanding, even if only one person would be responsible for creating the training material. The situation gets even more challenging when more people get involved in the creation process. The availability of similar and almost similar looking images at hand would greatly increase the consistency of the training material creation process and subsequently the classification accuracy of the supervised automatic classifier. The benefit of having consistent and error-free training material is obvious when any supervised automatic classifier is trained and tested.

For any image classifier, manual or automatic, a huge amount of testing samples may be needed for verifying the results of the classifying process. Browsing through labeled or classified images linearly or in random order is burdensome. The situation gets even more time consuming and labor intensive when many of the label classes are visually very similar. The availability of similar looking images with corresponding labeling at hand will greatly increase the quality of the manual verifying process.

### SUMMARY OF THE INVENTION

The purpose of this invention is to solve the above problems and create a new method for labeling images efficiently even when the number of images is large and create also a new and effective method for creating training material for a supervised classifier.

The labeling of images of a large image collection is a very time-consuming and labor-intensive task if done image by image. In order to label all the images, the user must go through the whole collection one by one. The rules and definitions of the correct labeling may change many times during the process if no overall view of the image collection is available. Also the user may forget the rules and definitions used before. This is particularly true if the user changes during the labeling process. Also the overall distribution of the visual appearances of the images of an image collection is difficult to present if the collection consists of thousands of images. To make the labeling process faster and more consistent and to visualize the overall distribution of visual appearances of the images a new method is proposed.

According to the first aspect of the invention, the method for labeling images having a visual appearance, which images are digitized in order to create image data, comprises: a plurality of features is calculated from at least one subset of said image data, the images are organized unsupervised in an organization process, whereby the organizing is based on at least one of the features and on a similarity criterion, any set of images are retrieved utilizing the organization of the stored images, at least one label is assigned to the image or to its part.

A very comprehensive view of the overall distribution of the image collection can be shown by organizing the image collection automatically based on the visual appearance of the images of the collection and by showing representative images for all the groups of similar images. Showing the contents of these groups at one view helps the user to rapidly give the images consistent labels. Comparing the different groups helps dividing the collection meaningfully and reduces the possible confusion and inconsistencies of the labeling process.

The use of the self-organizing map of the present invention as the means for automatically organizing the images is advantageous compared to conventional algorithms, because the map organizes the data based on the feature data only—no selection of sorting criteria is required from the user. The algorithm also automatically suggests representative sample images for all of the formed similarity groups.

With the method of the present invention for labeling images of a large image collection, the user can browse through groups of similar looking images. Exploring the image collection, which has been organized in a content-based manner, the user can consistently label the images.

In accordance with a second aspect of the invention there is a method for verifying the labeling of images having a visual appearance. The images are digitized in order to create image data, a plurality of features is calculated from at least one subset of said image data, the images are organized unsupervised in an organization process, whereby the organizing is based on at least one of the features and on a similarity criterion, any set of images is retrieved utilizing the organization of the stored images and the labeling of the retrieved image or its part is verified by comparing its visual appearance to the said set of images.

With the method of the present invention for verifying the labeling of images of a large image collection, the user can browse through groups of similar looking images. The user can efficiently verify the labeling of the images by utilizing the content-based ordering of the entire image collection.

According to a third aspect of the invention there is a method for creating training material for a supervised classifier. The training material consists of images having a visual appearance and the images are digitized in order to create image data. A plurality of features is calculated from at least one subset of said image data, the images are organized unsupervised in an organization process, whereby the organizing is based on at least one of the features and on a similarity criterion, any set of images is retrieved utilizing the organization of the stored images and at least one label is assigned to at least one retrieved image or to its part.

The method for creating training material for a supervised classifier allows the user to browse through images that are readily organized by their visual appearance. The automatic organizing of the images enables the user to see many similar or dissimilar defects at once, thus improving the quality of the created training material. By going through many similar looking defects at the same time, the risk of creating misclassifications or too many sub-classes is greatly reduced. Also the ability to compare defects of different types helps the correct division of the entire image material into meaningful classification classes.

By applying the methods described above, the time needed to create a reasonable set of training material images for, for example an image based paper web defect classifier, can be reduced to one fourth or even smaller portion, when compared to creating the training material image by image. Also the quality of the produced training material can be improved significantly.

According to a further aspect of the invention the apparatus for labeling images having a visual appearance, comprises a means for digitizing the images in order to create image data, a means for calculating a plurality of features from at least one subset of said image data, a means for organizing the images unsupervised in an organization process, whereby the organizing being based on at least one of the features and on a similarity criterion, a means for retrieving any set of images utilizing the organization of the stored images and a means for assigning at least one label to at least one retrieved image or to its part.

The above and other objects, features and advantages of the present invention will become more apparent from the following detailed description with accompanying drawings.

### BRIEF DESCRIPTION OF THE DRAWINGS

FIG. 1 is a schematic overview of a system in context of which the invention can be used;

FIG. 2 presents a digitized image of paper web with several defective areas;

FIG. 3 presents a flow chart describing the main steps of the invention;

FIG. 4 presents a matrix of representative images of paper web defects, each representing several similar looking defect images;

### DETAILED DESCRIPTION OF THE PREFERRED EMBODIMENT

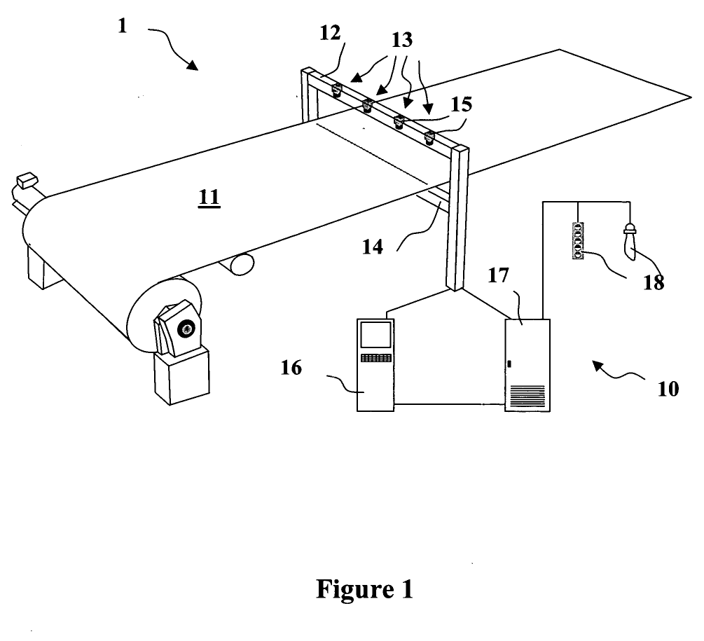

FIG. 1 illustrates an industrial application 1 of a visual inspection system 10, in connection of which the method for labeling images and creating training material can be used. This is an example where the visual inspection system represents any visual system, which takes and collects electronic images of various materials or objects for classifying different characteristics in them. Visual inspection system 10 may be applied for various continuous and discontinuous manufacturing lines. FIG. 1 illustrates a case in which the visual inspection system 10 is inspecting a moving and continuous web 11 manufactured on a process line such as a paper machine.

The moving web 11 is viewed by one or several cameras 13 from one side of the web 11. The cameras 13 are mounted on a suitable mechanical support such as a camera beam 12. The web 11 is illuminated from underneath by a light source 14. The light source may also be located above the web 11. Transmitting light, as illustrated in FIG. 1 is favorably used for translucent materials. Reflecting light is suitable especially for other types of materials. With the reflecting light the illumination angle may either be specular or diffuse in respect to the camera-viewing angle.

The cameras 13 may be any types of electronic cameras, which can be directly or indirectly coupled to image processing unit 15. Functions of the image-processing unit 15 may also be integrated with the camera 13, in which case the camera 13 is a more complicated and self-contained image-processing unit. Image data output of an analog camera, for example an analog CCD line scan or matrix camera, has to first be converted to digital format. Digital camera output is typically more ready for digital processing in the image processing unit 15. The image-processing unit 15 receives from the cameras 13 a digital representation of the view imaged by the cameras 13. The representation is in the form of a series of digital numbers. Image processing unit 15 interprets this data as an electronic image, which is elsewhere referred to as an image, on the basis of the information it has about the properties of the camera 13. For example, the image processing unit 15 combines the successive series of data sent by a camera of line scan type to form a matrix that represents an image of the web 11.

The image-processing unit 15 is a separate, typically programmable, hardware unit. It can be partially or totally integrated with the camera, as depicted in FIG. 1. It can be also a personal computer or any other type of universal computer. One computer may take care of image data processing of one or several cameras. The outcome of this processing stage is a set of electronic images representing selected parts of the web, the images being manipulated electronically to meet requirements of the application at hand.

The images are forwarded to the next processing step, which is image analysis. This step can be done in a separate computer, which may be a part of an operator station 16 of the visual inspection system 10 and it is typically common to all the cameras 13. Image analysis comprises, for example, segmentation for finding the interesting areas, such as defects, in the image. After segmentation, features describing properties of the regions found by segmentation can be extracted. The features are numeric values that will be used in recognizing the areas, i.e. in classifying them.

Operator station 16 contains the user interface of the visual inspection system 10. It is used for entering various tuning parameters and selecting desired displays and reports, which for example show the status of the system and the quality of the inspected products. Naturally the visual inspection system 10 requires separate means for supplying power to the system and devices for interfacing with the external systems such as the process itself. These means, which are well known to those of ordinary skill in the art, can be located in an electronic cabinet 17. In addition to operator station 16, external devices 18 can be used for alerting the operator.

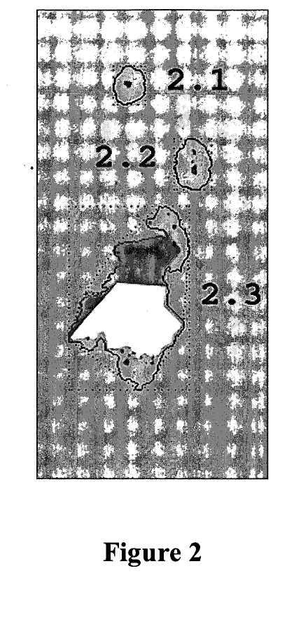

The image data is stored in an image database. The image collection of the database consists of different types of digitized paper web defects. The defects are detected and their images are digitized from a running paper web. An example of the paper web defects is shown in FIG. 2. The defective areas are the objects of interest in the image and are marked with a dash line. The two smaller defects in the image, 2.1 and 2.2, are dirt spots with a wet surrounding. The larger area, 2.3, is a slime hole having wet surroundings. Also some remnants of the slime that caused the hole can be seen near the hole. Digital line-scan cameras acquire the defect images with transmission lighting and the images are stored to an image database together with a set of calculated features associated with certain areas of the image. A plurality of such defect images with a varying number of defects and associated features in each image form an image collection.

In order to handle and analyze the image data of the web defects the images must be classified using some meaningful criteria. A supervised classifier can be used only after training it. For training, samples, in this case images containing objects to be classified, are needed with a label or labels assigned by a human expert.

The labeling of images of a large image collection with a certain criterion is a labor-consuming and demanding task. A human user is often required to do the labeling, and any automation of the labeling of images is in general error-prone. The task is even more demanding when no predefined criteria for labeling the images can be presented to the user responsible for the generation of the label. The invention presents a method for aiding the user in this task. The automatic and content-based organization of the images helps the user to select and fetch some groups of images of interest for a closer inspection and possible labeling of selected images. The content-based manner of the organization enables the user to select the interesting groups of images while neglecting the rest of the large image collection.

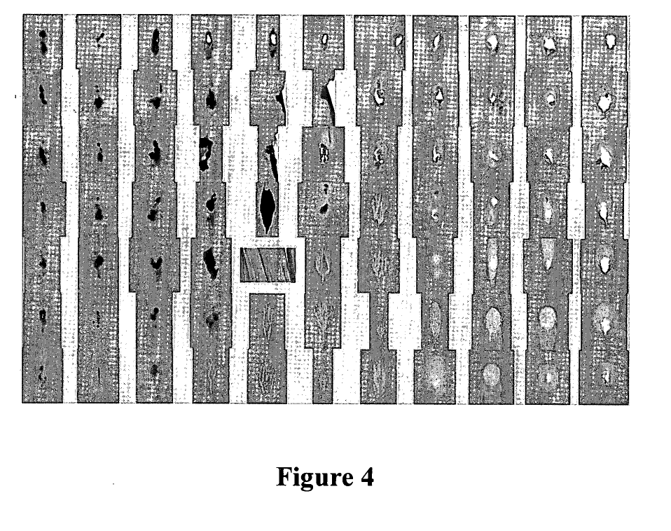

In FIG. 4 there is shown a visual appearance of digitized images of different types of paper web defects. Actually, each of these images is a representative of a group of images whose feature vectors are close to each other. As can be seen, the automatic organization provides an image matrix where similar looking images, or images of similar looking objects, are close to each other. The user can easily select the desired areas of interest from the organized image matrixes to retrieve more images of the similar visual appearance. After retrieving similar images or images of similar looking objects, the user can rapidly and consistently assign them with the desired labels.

In a further aspect of the invention the labeling of the image collection can be used to train a supervised image classifier. The division of classifiers, or models, into supervised and unsupervised models is defined by the involvement of a human expert in the parameterization or optimization stage of the model creation process. If any input from a human expert is needed for parameterization or optimizing the model, the classifier can be considered as a supervised classifier. If no user input affects the model creation process, the model enclosing classifier can be considered as an unsupervised classifier.

Supervised classifiers use examples of labeled, or pre-classified, data as the basis for a model fitting process. Typically a human expert familiar with the data does the labeling. The supervised classifiers, in general, rely only on the provided training data samples, the labeled data. There are several different types of supervised classifier models sharing the same basic principles. The algorithms for the selection and optimization of the model and the model parameters depend on the type of the supervised classifier used. In all cases, the results of the tested supervised classifier are strongly dependent on the quality of the provided training material, that is, the labeled example data. Consistent and carefully selected and labeled training material improves the results of any supervised classifier compared to inconsistent and erroneous training material.

When supervised image classifiers are considered the selection and labeling of a comprehensive training image material is a burdensome, but nevertheless crucial, task. The interpretation of the imaged objects is rarely free of subjective preferences and the distinction of different classes is often somewhat fuzzy. In this context the presented invention gives an invaluable insight into the distribution of different visual appearances of the image collection and thus reduces the amount of iterative labeling cycles needed for a comprehensive and consistent image based training material.

A method is also presented for helping the user to verify a labeling already made by some instance. The label to be verified may have been made by the user himself/herself or by another human inspector or it may be generated automatically. A supervised image classifier might produce the automatic labeling, for example. In such a case, it is often particularly important to verify some portions of the labeled image collection. These portions are for example groups of images, where misclassifications can be expected. In such a case, it is advantageous, that the image collection can be browsed in a content-based manner, having similar kinds of labeled images at hand. In the automatic image classification scheme, a labeling process frequently follows the verifying process, when misclassifications of an automatic or manual image classifier are corrected to produce more comprehensive training material for a supervised image classifier.

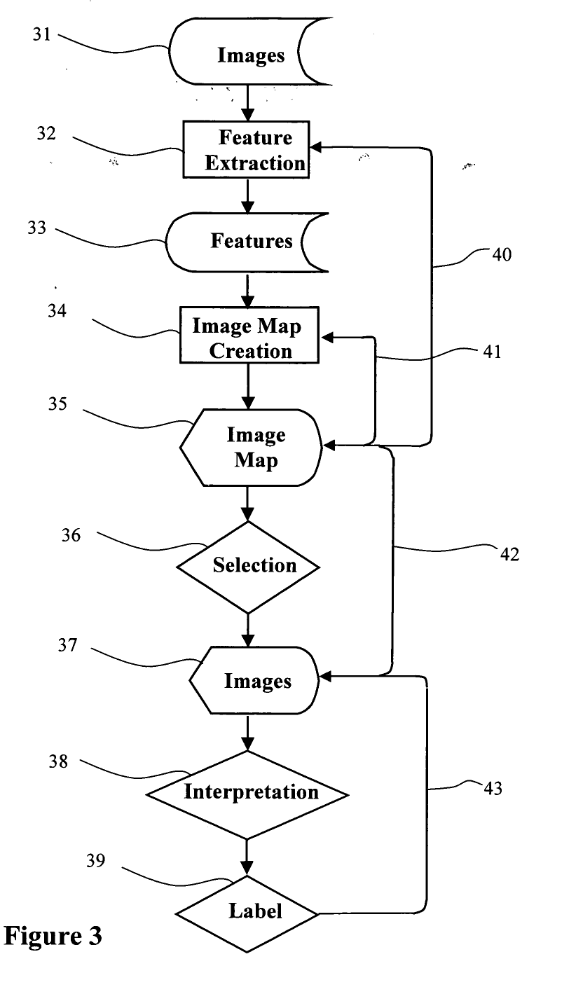

To further clarify the use of labeling of images, an example is provided here, where the labeling is used for creating training material for a supervised image classifier. This image collection can be labeled and labeling verified by a process depicted in FIG. 3.

Referring to FIG. 3, the image collection at stage 31 is formed after the defect images are stored in a storing device, for example an image database. The images are processed and the associated features are extracted at stage 32. The image processing stage consists, for example, of applying a double-sided threshold to the image and defining regions of interest from the resulting binary image. Different spatial operators, like morphological masks etc, can further be applied to process the regions of interest. The features describing the defect can be calculated using the processed regions of interest and the original defect image. The set of features typically consists of features like size, angle, principal component ratio, maximum intensity and other such features describing the essential aspects of the appearance of the defect. External features can also be used to improve the organization and classification results. These features can be any external data related to the defect, for example process parameters describing the state of the manufacturing process.

At stage 33, following the feature extraction process, the calculated features are stored and they represent the image data to the next stage. The image collection is organized based on the features and in a content-based manner at stage 34. This enables the browsing and visualization of the image collection at stage 35. Here the self-organizing map algorithm, or SOM, described in Kohonen, is utilized, which organizes the images based on the similarity of the describing features.

In the following the incremental-learning variant of the SOM algorithm is described briefly. There are also several modifications to the following algorithm, for example the batch-learning algorithm, leading to almost similar results with reduced computational effort.

When applying the incremental-learning algorithm for the SOM, the regression of an ordered set of model vectors mᵢε [symbol] ⁿ, where i denotes the index of a node and [symbol] ⁿ denotes n-dimensional space of the real numbers, into the space of observation vectors xε [symbol] ⁿ is made by the following process:
mᵢ(t+1)=mᵢ(t)+h_{c(x),i}(x(t)−mᵢ(t)), (1)
where t is the sample index of the regression step, whereby the regression is performed recursively for each presentation of a sample of x. Index c, the “winner” model vector, is defined by the condition
∥x(t)−m_{c}(t)∥≦∥x(t)−mᵢ(t)∥ for all i. (2)
Here h_{c(x),i} is called the neighborhood function, and it acts as a smoothing kernel that is time- and location-dependent according to the condition in equation (2). It is a decreasing function of the distance between the ith and cth model vectors on the map grid. The neighborhood function is often taken to be the Gaussian

$${h}_{c ( x ) , i} = α ( t ) exp ( \frac{{‖ {r}_{i} - {r}_{c} ‖}^{2}}{2 {σ}^{2} ( t )} ) , \qquad ( 3 )$$

where 0<α<1 is the learning-rate factor, which decreases monotonically with the regression steps, rᵢε [symbol] ² and r_{c}ε [symbol] ² are the vectorial locations in the display grid, and σ(t) corresponds to the width of the neighborhood function, which is also decreasing monotonically with the regression steps. The above algorithm can be generalized by defining various generalized matching criteria.

In this embodiment of the invention, the similarity measure is the Euclidean distance metric for the n-dimensional features, but other metrics could be used as well. The features have been normalized to zero mean and equal variance to justify the use of the Euclidean distance as the similarity measure. The organized collection is then visualized by showing one representative image for every map node of the map created with the SOM algorithm. The SOM algorithm preserves some of the topology of the high dimensional feature space while adapting a two-dimensional grid into the data samples. All data samples of the n-dimensional feature space are mapped into exactly one of the nodes of the SOM grid. While the feature vectors are associated with certain parts of one defect image, they are also assigned to one node of the map; together with other similar feature vectors. This is one of the key attributes of the present invention: the visual appearance of the image or imaged object is described by a feature vector, which is in turn associated with other feature vectors through the organization, enabling the retrieving and presentation of the corresponding similar images or imaged objects. The SOM algorithm has inherently a two-dimensional grid that can naturally be presented also as a matrix with one representative image for each cell. The organization of the SOM algorithm also follows loosely the statistics of the feature space, thus the image matrix has more representative images for the defect types having more samples in the collection. The number of samples in the input data can be used to adjust the size of the map, that is, the number of nodes in the grid of the map. The more there are feature vectors, which represent the defect images, in the input data, the bigger the map should be. A rate of one to fifty could be used, for example, to set the number of map nodes by the number of feature vectors. For ten thousand defects this leads to a map with two hundred nodes, with an average of fifty defects per node. The map behaves better if it is not square, so the width and height of the map could set to ten and twenty in this example. The learning parameters of the SOM algorithm can also be adjusted based on the dimensions of the input data. After the map is automatically organized, each map node has a varying number of defect images associated with it. The representative images of the nodes represent these sets of similar images, which can be retrieved by selecting the map nodes of interest.

The organization of the images improves the selection process at stage 36, where the desired subset of similar or dissimilar images is retrieved and visualized. When a set of defect images is retrieved, the individual defects are visualized as an image matrix 37. At stage 38 the user can interpret the appearance of a defect under inspection based on the defect image and assign a label 39 to it. All of the aforementioned steps may be iterated until a satisfactory amount of training material is created, as shown by the iteration arrows 40 to 43. The feature extraction phase can be iterated 40 as necessary and different feature sets can be computed with varying algorithms and parameters. The creation of the image matrix, or image map, can be iterated 41 and the training parameters of the SOM can be changed to produce somewhat different image maps. Once an image map is created, different areas of the map can be explored in more detail. The selection of the image groups from the map can be iterated 42 as well. The labeling of retrieved images may also be repeated 43 until all images have been labeled or relabeled. Any aforementioned iteration step can be initiated at any stage as shown by the iteration arrows.

The created training material may be verified with a similar process, differing only on the last stage, where the labeling is presented together with the images. The verifying process can further be immediately followed by a labeling process, where the labeling may be changed by the verifying user. The aforementioned process of labeling images and verifying image labeling can be used for creating training material sets for any supervised image classifier. The described verifying process can also be used to efficiently verify the results of a trained supervised image classifier.

In an advantageous embodiment the method is performed using a computer. The programs to be used are stored in the memory of the computer or on a computer readable media, for example a CDROM, that can be loaded on a computing device. These computer readable mediums have instructions for causing the computer to execute a method.

Various changes can be made to the invention without departing from the spirit thereof or scope of the following claims.

1. A method for labeling images having a visual appearance, wherein digitizing the images in order to create image data; the method comprising: calculating a plurality of features from at least one subset of said image data; organizing the images unsupervised in an organization process; whereby the organizing being based on at least one of the features and on a similarity criterion; retrieving any set of images utilizing the organization of the stored images; assigning at least one label to at least one retrieved image or to its part.

2. A method according to claim 1, wherein making the organization of the images visible on an output device.

3. A method according to claim 1, wherein making the retrieved images visible on an output device.

4. A method according to claim 1, wherein making the organization of the images visible on an output device and making the retrieved images visible on an output device.

5. A method according to claim 1, wherein images are organized by utilizing the self-organizing map algorithm.

6. A method according to claim 1, wherein labeling the images in order to create a training material, which is used for training a supervised image classifier for classifying defects of material under inspection.

7. A method according to claim 1, wherein snapping the images from a material under inspection.

8. A method for verifying the labeling of images wherein the images have a visual appearance and wherein digitizing the images in order to create image data; the method comprising: calculating a plurality of features from at least one subset of said image data; organizing the images unsupervised in an organization process; whereby the organizing being based on at least one of the features and on a similarity criterion; retrieving any set of images utilizing the organization of the stored images; verifying the labeling of the retrieved image or its part by comparing its visual appearance to the said set of images.

9. A method according to claim 8, wherein making the organization of the images visible on an output device.

10. A method according to claim 8, wherein making the retrieved images visible on an output device.

11. A method according to claim 8, wherein making the organization of the images visible on an output device and making the retrieved images visible on an output device.

12. A method according to claim 8, wherein organizing images by utilizing the self-organizing map algorithm.

13. A method according to claim 8, wherein labeling the images in order to create a training material, which is used for training a supervised image classifier for classifying defects of material under inspection.

14. A method according to claim 8, wherein snapping the images from a material under inspection.

15. A method for creating training material for a supervised classifier wherein the material consists of images having a visual appearance and wherein digitizing the images in order to create image data; the method comprising: calculating a plurality of features from at least one subset of said image data; organizing the images unsupervised in an organization process; whereby the organizing being based on at least one of the features and on a similarity criterion; retrieving any set of images utilizing the organization of the stored images; assigning at least one label to at least one retrieved image or to its part.

16. A method according to claim 15, wherein making the organization of the images visible on an output device.

17. A method according to claim 15, wherein making the retrieved images visible on an output device.

18. A method according to claim 15, wherein making the organization of the images visible on an output device and making the retrieved images visible on an output device.

19. A method according to claim 15, wherein organizing images by utilizing the self-organizing map algorithm.

20. A method according to claim 15, wherein labeling the images in order to create a training material, which is used for training a supervised image classifier for classifying defects of material under inspection.

21. A method according to claim 15, wherein snapping the images from a material under inspection.

22. An apparatus for labeling images having a visual appearance, comprising: a means for digitizing the images in order to create image data; a means for calculating a plurality of features from at least one subset of said image data; a means for organizing the images unsupervised in an organization process, whereby the organizing being based on at least one of the features and on a similarity criterion; a means for retrieving any set of images utilizing the organization of the stored images; and a means for assigning at least one label to at least one retrieved image or to its part.

23. An apparatus according to the claim 22, which comprises a means for verifying the labeling of the retrieved image or its part by comparing its visual appearance to the said set of images.

24. An apparatus according to the claim 22, which comprises a means for creating training material for a supervised classifier.
